(19) United States
(12) Patent Application Publication
(10) Pub. No.: US 2004/0082890 A1
(43) Pub. Date: Apr. 29, 2004

(54) Foot kneading rug having bulges of different hardnesses

(76) Inventor: Chun Fu Kuo, Taichung Hsien (TW)

Correspondence Address: CHARLES E. BAXLEY, 5th Floor, 59 John Street, New York, NY, 10038, US

(21) Appl. No.: 10/280,292

(22) Filed: Oct. 28, 2002

(51) Int. Cl. A61H 7/00

(52) U.S. Cl. 601/134; 601/28; 601/22

(57) ABSTRACT

A foot kneading rug includes a base panel having a number of bulges and swellings extended upwardly from the upper portion of the base panel. The swellings may include a height greater than that of the bulges, and may include a hardness greater than that of the bulges for resiliently supporting users' feet before the users' feet contacting with the bulges. An anti-slippery device includes a sheet member secured to the bottom portion of the base panel, and a number of suction cups attached to the sheet member for anti-slippery purposes.

### BACKGROUND OF THE INVENTION

1. Field of the Invention

The present invention relates to a foot kneading rug, and more particularly to a foot kneading rug having a number of bulges or swellings having different hardnesses.

2. Description of the Prior Art

Various kinds of typical foot kneading rugs have been developed and comprise a number of projections or bulges or swellings extended upwardly from a base panel, for massaging purposes. One example of the typical foot kneading rugs is disclosed in U.S. Pat. No. 2,820,454 to Wright.

However, the projections or bulges or swellings that are extended upwardly from the base panel include an identical height and have an identical hardness, such that the users may not be suitably massaged with the rugs when the projections or bulges or swellings do not include a suitable hardness.

On the contrary, when the projections or bulges or swellings are too hard or include a hardness that the users may not endure, the users may feel hurt or the feet of the users may be hurt by the hard swellings.

The present invention has arisen to mitigate and/or obviate the afore-described disadvantages of the conventional foot kneading rugs.

### SUMMARY OF THE INVENTION

The primary objective of the present invention is to provide a foot kneading rug including a number of bulges or swellings having different hardnesses and/or heights for suitably massaging the feet of the users.

The other objective of the present invention is to provide a foot kneading rug including a number of anti-slippery devices or members or suction cups for anti-slippery purposes.

In accordance with one aspect of the invention, there is provided a foot kneading rug comprising a base panel including an upper portion, a plurality of bulges extended upwardly from the upper portion of the base panel, and a plurality of swellings extended upwardly from the upper portion of the base panel, and including a height greater than that of the bulges, and including a hardness greater than that of the bulges for resiliently supporting users' feet before the users' feet contacting with the bulges.

The base panel includes a bottom portion having an anti-slippery device provided thereon for anti-slippery purposes. For example, the anti-slippery device may include a sheet member secured to the bottom portion of the base panel, and a plurality of suction cups provided on the sheet member, for solidly attaching or securing onto the supporting ground surface, and for preventing the rug from moving relative to the supporting ground surface.

The anti-slippery device preferably includes a cloth layer, such as a woven or non-woven cloth layer disposed between the sheet member and the bottom portion of the base panel.

A cover layer may further be applied onto the softer swellings and/or the harder bulges and/or the sheet member, for suitably contacting with the users.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a foot kneading rug in accordance with the present invention;

FIG. 2 is a cross sectional view taken along lines 2-2 of FIG. 1;

FIG. 3 is an enlarged partial cross sectional view of the foot kneading rug; and

FIGS. 4, 5, 6 are enlarged partial cross sectional views illustrating the formation of the foot kneading rug.

### DETAILED DESCRIPTION OF THE PREFERRED EMBODIMENT

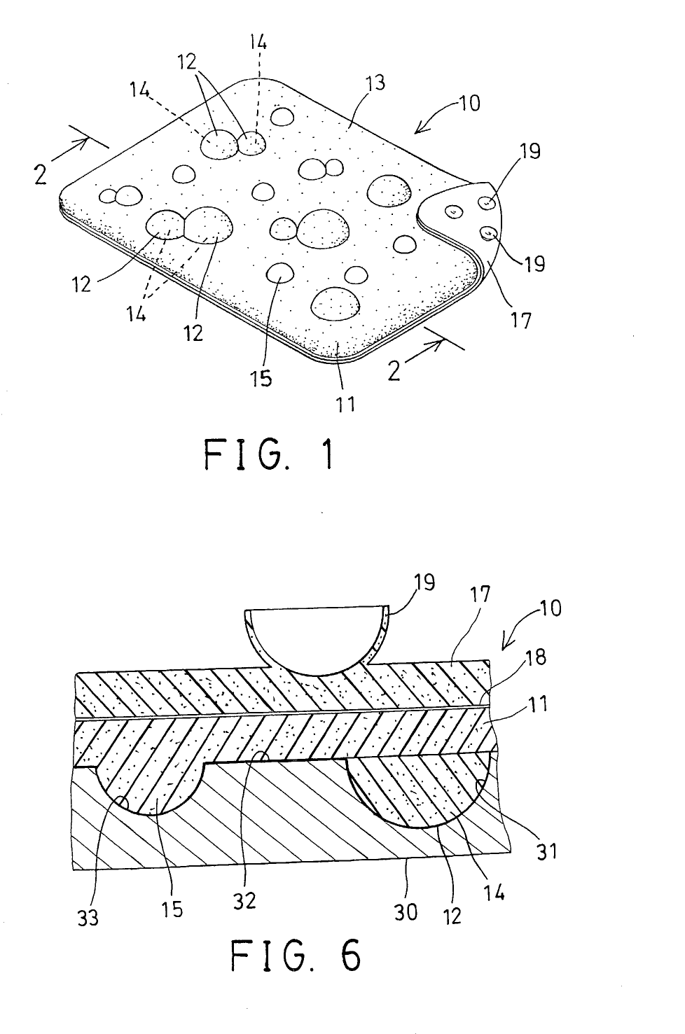

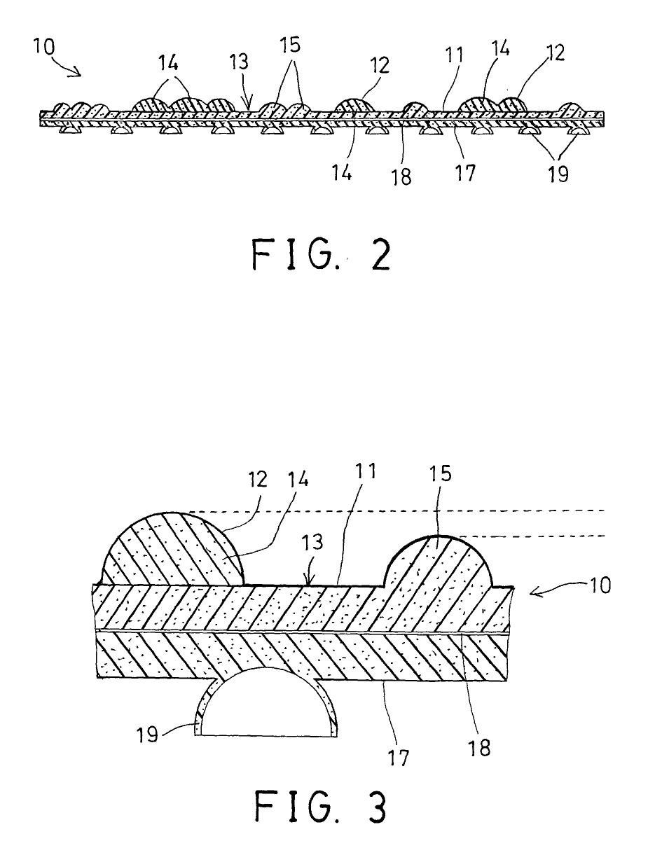

Referring to the drawings, and initially to FIGS. 1-3, a foot kneading rug 10 in accordance with the present invention comprises a base panel 11 including a number of swellings 14 and a number of bulges 15 extended upwardly from the upper portion 13 thereof.

The base panel 11 and the swellings 14 and the bulges 15 are made of similar polymer materials, such as polyurethane elastomer or polyurethane foam materials, having different hardnesses. For example, the swellings 14 include a height greater than that of the bulges 15, and include a hardness smaller than that of the base panel 11 and/or the bulges 15.

In operation, as shown in FIG. 3, the feet of the users may step onto the softer swellings 14 before contacting or engaging with or stepping onto the harder bulges 15. The softer swellings 14 may suitably or comfortably support the feet of the users before the feet contact or engage with the harder bulges 15.

The feet of the users may thus have several portions resiliently supported by the softer swellings 14, and may have the other portions suitably engaged with and massaged by the harder bulges 15.

The polymer materials, such as polyurethane elastomer or polyurethane foam materials, for forming or for making the swellings 14 and the bulges 15 may be sticky and may not be suitably contacted with the users.

Accordingly, it is preferably that a polyurethane cover layer 12 may further be applied onto the outer peripheral portions of the swellings 14 and/or of the bulges 15 and the base panel 11, and may include a non-sticky characteristic for contacting with the users.

The foot kneading rug 10 may further include a number of anti-slippery devices or members 19 attached to the bottom thereof, such as the suction cups 19 attached to the bottom of the foot kneading rug 10, for attaching or securing the foot kneading rug 10 onto the supporting ground or surface, and for preventing the foot kneading rug 10 from moving relative to the supporting ground or surface.

For example, the foot kneading rug 10 may thus be stably attached or secured onto the supporting ground or surface of the swimming pools, the bath rooms, or the like, and may be used for stably and safely supporting the users, and additionally, for massaging the feet of the users.

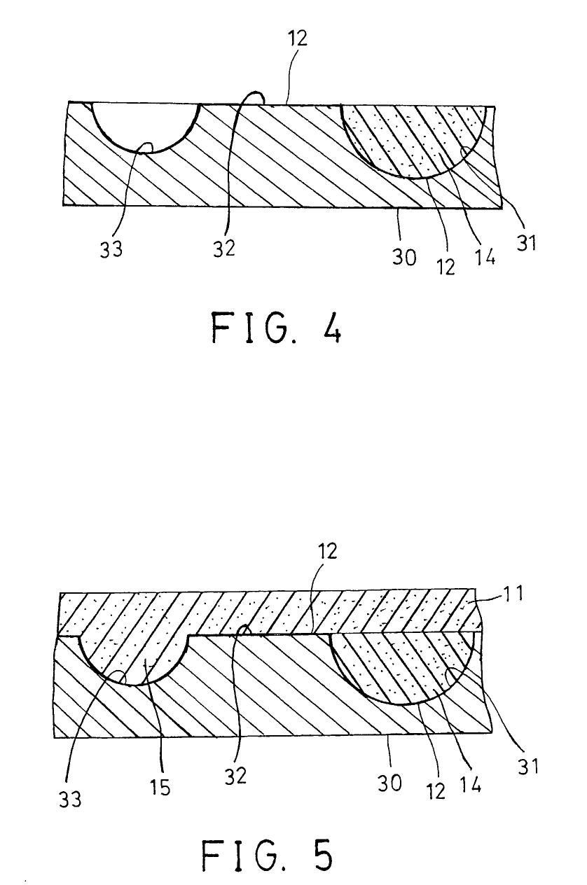

Referring next to FIGS. 4-5, illustrated are the processes for manufacturing the foot kneading rug 10. For example, a mold device 30 may be provided and may include a number of mold cavities 31, 33 formed in the upper portion 32 thereof, or concave from the upper portion 32 thereof, and having shapes corresponding to those of the swellings 14 and the bulges 15 respectively.

As shown in FIG. 4, the polyurethane material for forming the cover layer 12 is first applied onto the inner peripheral portion of the cavities 31, 33 and the upper portion 32 of the mold device 30, and is heated to a temperature ranging from 50 to 80° C., and last for about 5 to 10 minutes, for allowing the cover layer 12 to be suitably dried, but preferably not completely dried.

The polyurethane material for forming the softer swellings 14 is then applied or filled into the mold cavities 31 of the mold device 30, and may also be suitably heated in order to be suitably dried, but preferably not completely dried.

The polyurethane material for forming the harder bulges 15 and the base panel 11 is then applied or filled into the other mold cavities 33 of the mold device 30, and may also be suitably heated in order to be suitably dried, for allowing the similar polyurethane materials for forming the softer swellings 14 and for forming the harder bulges 15 and the base panel 11 to be suitably secured or adhered together before the similar polyurethane materials are completely dried or hardened.

The polyurethane materials for forming the softer swellings 14 and for forming the harder bulges 15 and the base panel 11 may include primarily the polyol materials, and the glycol ether materials, and may include agents, such as MDI materials mixed therein.

For example, the polyurethane material for forming the cover layer 12 may include a greater amount or proportion of the MDI materials than the polyurethane material for forming the softer swellings 14, which may include a greater amount or proportion of the MDI materials than the polyurethane material for forming the harder bulges 15 and the base panel 11.

Alternatively, the polyurethane cover layer 12 may also be made of thermoplastic polyurethane (TPU) which can be prepared on the basis of aromatic, aliphatic or alicyclic isocyanates. The cover layer 12 may be applied onto the softer swellings 14 only, but preferably applied onto the harder bulges 15 also.

Referring next to FIG. 6, a sheet member 17 may further be or selectively be provided and secured to the bottom of the base panel 11, and may include a woven or non-woven cloth layer 18 attached or secured thereon, and secured onto the bottom of the base panel 11 before the base panel 11 is completely cured or hardened.

For example, the sheet member 17 may also be made of similar polyurethane materials, or the other polymer materials, synthetic materials, or the like, and the woven or non-woven cloth layer 18 may be attached or secured onto the sheet member 17 before securing onto the bottom of the base panel 11.

The anti-slippery devices or members 19 may include the suction cups 19 attached or secured to or provided on the bottom of the sheet member 17 of the foot kneading rug 10, for stably and solidly attaching or securing the foot kneading rug 10 onto the supporting ground or surface, and for preventing the foot kneading rug 10 from moving relative to the supporting ground or surface.

The foot kneading rug 10 preferably includes a specific weight or gravity greater than one “1”, for preventing the rug 10 from floating on water, and for stably attaching the rug 10 onto the supporting ground surface of the swimming pools, the bath rooms, or the like, where may be slippery and may be dangerous for the users. The rub 10 may thus be used for stably and safely supporting the users, and additionally, for massaging the feet of the users.

Accordingly, the foot kneading rug in accordance with the present invention includes a number of bulges or swellings having different hardnesses and/or heights for suitably massaging the feet of the users, and includes a number of anti-slippery devices or members or suction cups for anti-slippery purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A foot kneading rug comprising:
a base panel including an upper portion,
a plurality of bulges extended upwardly from said upper portion of said base panel, and
a plurality of swellings extended upwardly from said upper portion of said base panel, and including a height greater than that of said bulges, and being softer than said bulges for resiliently supporting users' feet before the users' feet contacting with said bulges.

2. The foot kneading rug according to claim 1, wherein said base panel includes a bottom portion having an anti-slippery device provided thereon for anti-slippery purposes.

3. The foot kneading rug according to claim 2, wherein said anti-slippery device includes a sheet member secured to said bottom portion of said base panel, and a plurality of suction cups provided on said sheet member.

4. The foot kneading rug according to claim 3, wherein said anti-slippery device includes a cloth layer disposed between said sheet member and said bottom portion of said base panel.

5. The foot kneading rug according to claim 1 further comprising a cover layer applied onto said swellings.
